(19) United States
(12) Patent Application Publication
(10) Pub. No.: US 2009/0048730 A1
(43) Pub. Date: Feb. 19, 2009

(54) METHOD AND SYSTEM FOR PLANNING REPAIR OF AN ENGINE

(75) Inventors: Srinkanth Akkaram, Guilderland, NY (US); Richard Scott Bourgeois, Albany, NY (US); James Kenneth Aragones, Clifton Park, NY (US); Michael Evans Graham, Slingerlands, NY (US); Nirm Velemylum Nirmalan, Niskayuna, NY (US); Sridhar Adibhatla, Glendale, OH (US); Maria Cecilia Mazzaro, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/840,409

(22) Filed: Aug. 17, 2007

(51) Int. Cl. G01M 17/007

(52) U.S. Cl. 701/29

(57) ABSTRACT

A method for planning repair of an engine is provided. The method comprises monitoring an engine having a plurality of engine modules and determining one or more module-specific health estimates for one or more of the engine modules, based on a plurality of engine parameters. The method further comprises planning repair of the engine based on one or more of the module-specific health estimates determined for one or more of the engine modules.

### BACKGROUND

The invention relates generally to gas turbine engines, and more particularly to a system and method for planning the repair and maintenance of an aircraft engine.

As gas turbine engines operate, engine efficiency, performance and life consumption rates may deteriorate over time, due to various factors such as engine wear and damage and engine erosion. The rate at which engines deteriorate generally depends upon several operational factors. Therefore, engine components are typically scheduled for maintenance based upon a pre-selected number of hours or cycles. In general, an engine is required to come for a service shop visit if any of its life limited parts (LLP) have been used for a pre-specified number of cycles as part of a scheduled visit, or if a particular engine demonstrated a significant negative performance trend that could be specific to that particular engine's construction or usage as part of a performance related visit. An engine may also need to be serviced for a number of other reasons such as to repair damage to the aircraft engine, to restore operating performance of the aircraft engine, to inspect or repair safety flaws in the aircraft engine, or to upgrade the aircraft engine for increased operating life.

Typically, at a repair shop, a service manager receives a package of documents containing the reason or reasons that the aircraft engine was removed from the wing of the aircraft for repair (e.g., damage, inspection, etc.), the customer's request that the engine be repaired to achieve a certain build level, the remaining life of each of the LLPs in the aircraft engine and service bulletins for the aircraft engine such as requirements for repair or inspection of parts, replacement of defective parts, or incorporation of manufacturer design changes. The service manager reviews the documents and develops a workscope planning document which is a general outline of the specific repairs to be performed to the aircraft engine. The developed workscope planning document is then reviewed, and if approved by the customer, the aircraft engine is then repaired.

It would be desirable to develop a technique to enable a service manager to be able to automatically identify engine specific repairs or overhauls required for a workscope, so that desired performance levels as a result of the workscope can be achieved. In addition, it would be desirable to develop a technique to efficiently plan the repair and overhaul of an engine based on engine specific component health estimates, so that the repair and overhaul of the engine may be performed in less time, with increased accuracy and efficiency, reduced cost, and increased time-on-wing.

### BRIEF DESCRIPTION

In one embodiment, a method for planning repair of an engine is provided. The method comprises monitoring an engine having a plurality of engine modules and determining one or more module-specific health estimates for one or more of the engine modules, based on a plurality of engine parameters. The method further comprises planning repair of the engine based on one or more of the module-specific health estimates determined for one or more of the engine modules.

In another embodiment, a system for planning repair of an engine is provided. The system comprises an engine module health estimation component, an engine modeling component and an engine repair estimation component. The engine module health estimation component is configured to determine one or more module-specific health estimates for one or more engine modules, based on a plurality of engine parameters. The engine modeling component is configured to evaluate one or more of the module-specific health estimates based on the plurality of engine parameters and a model of the engine. The model of the engine predicts engine performance based on the plurality of engine parameters. The engine module repair estimation component is configured to plan repair of the engine based on one or more of the evaluated module-specific health estimates.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of one embodiment of a system for planning repair of an engine, based on engine module health estimates; and

FIG. 2 illustrates one or more process steps that may be used by the system of FIG. 1, for planning repair of an engine, based on engine module health estimates.

### DETAILED DESCRIPTION

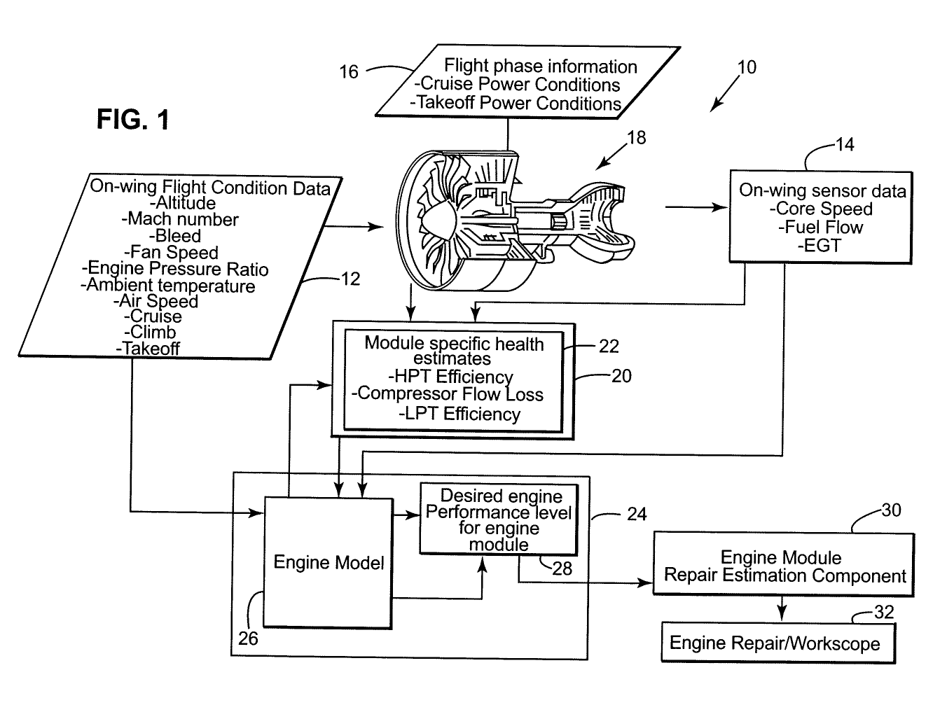

FIG. 1 is an illustration of one embodiment of a system for planning repair of an engine, based on engine module health estimates. In one embodiment, the system 10 is an aircraft engine, having a plurality of engine modules. However, it should be appreciated that the disclosed system may also be configured to plan the repair and overhaul of other types of engines, such as, for example, land based power generation engines, marine transportation engines and machine tools, as well as other types of mechanical systems amenable to a mathematical model of their normal operating behavior.

Referring to FIG. 1, the system 10 generally comprises an engine 18, an engine module health estimation component 20, an engine modeling component 24 and an engine module repair estimation component 30. The engine 18 includes a plurality of sensors, configured to monitor a plurality of engine parameters related to the operation and performance of the engine 18. In one embodiment, the plurality of engine parameters include on-wing flight condition data 12 and on-wing sensor data 14 related to the operation and performance of the engine 18. The on-wing flight condition data 12 may include, but is not limited to, altitude, aircraft mach number, bleed, ambient temperature, air speed, ambient pressure and engine power setting parameters such as fan speed or engine pressure ratio. The on-wing sensor data 14 may include, but is not limited to, exhaust gas temperature, rotor speeds, engine temperature, engine pressure, gas temperature, engine fuel flow, core speed, compressor discharge pressure, turbine exhaust pressure and fan speed. The plurality of sensors may also be configured to monitor information such as, for example, ground test or production test information related to the operation of the engine 18. The plurality of sensors may also be configured to monitor engine parameters related to various phases of engine operation 16, to extract specific data during flight phases of interest, such as, for example, take off, climb and steady cruise. The engine parameters may be recorded onboard by the plurality of sensors, and accessed later by ground maintenance personnel for processing or remotely transmitted to ground locations during flight operations for real-time processing by the engine modeling component 24, as will be described in greater detail below.

The engine module health estimation component 20 is configured to determine one or more module-specific health estimates 22 for one or more of the engine modules comprising the engine 18, based on the plurality of engine parameters. In one embodiment, the plurality of engine modules comprising the engine 18 may include, but are not limited to, a fan module, a core module, a compressor module, a high-pressure turbine module and a low-pressure turbine module and the module-specific health estimates 22 may include, but are not limited to a fan flow, a fan efficiency, a booster flow, a booster efficiency, a high pressure compressor flow, a high pressure compressor efficiency, a combustor efficiency, a high pressure turbine flow function, a high pressure turbine efficiency, a low pressure turbine flow function and a low pressure turbine efficiency related to the engine 18.

In one embodiment, the module-specific health estimates 22 may further be determined based on a parameter identification technique that measures the difference between the sensed engine parameters and a plurality of model parameters corresponding to sensor predictions derived from an engine model. The parameter identification techniques may further be used to determine the module-specific health estimates 22 by matching/mapping the sensed engine parameters to the corresponding model parameters. The parameter identification technique may include, but is not limited to, a Kalman filter, a tracking filter, a regression map, a neural map, an inverse modeling technique or a combination thereof. The Kalman filter may include a modified Kalman filter, an extended Kalman filter, a particle filter or an unscented Kalman filter. The tracking filter may include proportional and integral regulators or other forms of square (n-inputs, n-outputs) or non-square (n-input, m-outputs) regulators.

In another embodiment, the module-specific health estimates 22 may further be determined based upon engine usage history, such as, for example, a most recent set of flights and/or a combination of multiple flight conditions, such as, for example, cruise and take-off, to obtain an accurate estimation of engine module health. Further, engine transient data may also be used to augment available steady-state engine data to obtain accurate health estimates for the engine modules. In another embodiment, the engine-module health estimation component 20 may also be configured to use nominal engine degradation information to augment any engine specific information that is desired and missing because of lack of sensor information. For example, a fleet average nominal degradation curve may be used as additional information in the estimation of engine module health in order to compensate for the lack of information (such as, for example, compressor exit pressure/temperature) from the plurality of sensors. The generation of the health estimates may also take into consideration, the varying fidelity (uncertainty) of information represented by the on-wing flight condition data 12 and the on-wing sensor data 14 (such as, for example, EGT, Fuel flow and Core speed). In addition, confidence bounds for the health estimates may be determined, to take into account sources of variation, and quantify risks in making subsequent decisions while planning the repair for the engine 18.

In yet another embodiment, the engine-module health estimation component 20 may further be configured to represent the health of the engine module based upon the module-specific health estimates determined for one or more of the engine modules. For example, the health of the high-pressure turbine (HPT) module may be represented as a function of the HPT blade health, the HPT rotor health and the HPT nozzle health. In another example, the health of the HPT blade may be represented as a function of the blade tip rub and the blade creep.

Referring to FIG. 1 again, the engine modeling component 24 is configured to evaluate one or more of the module-specific health estimates 22 determined by the engine-module health estimation component 20, based upon the plurality of engine parameters and a model of the engine. In one embodiment, the model 26 of the engine may include, but is not limited to, a physics-based model, a data fitting model (such as a regression model or a neural network model), a rule-based model, and an empirical model. As will be appreciated by those skilled in the art, a physics-based model may be used to relate engine performance degradation parameters to physical wear or usage. Observations of engine data may be used to identify changes in the performance of the specific engine over time, to observe trends and to determine whether adjustments can be made to the engine model to reflect engine operation accurately. In another embodiment, the engine model 26 may also be represented as an empirical model. Empirical data for a fleet of engines of a given type may be considered to determine the level of engine repair that produces improvements in the engine operational data and the health of the specific modules. The empirical data may be derived by observing changes in engine performance before and after the repair of the engine is performed, and this empirical data can be added to the engine model 26 to determine the impact of the level of repair needed for the engine.

In one embodiment, the model of the engine 26 predicts engine performance based on the plurality of engine parameters. In a particular embodiment, the engine modeling component 24 is configured to evaluate the module-specific health estimates 22 by varying one or more of the engine parameters and determining a desired engine-module performance level 28 for one or more of the engine modules comprising the engine. In one embodiment, the engine modeling component 24 may further be configured to evaluate the engine model 26 with varying values of the module-specific health estimates 22 generated for the engine modules, until the desired engine-module performance level 28 determined for one or more of the engine modules is achieved. For example, the parameter values associated with the revolutions per minute (RPM) and the engine fuel flow may be varied, to evaluate the module-specific health estimates determined for the compressor module and the turbine module and to determine a desired performance level for the Exhaust Gas Temperature (EGT) for the engine 18.

The engine module repair estimation component 30 is configured to determine a desired level of repair for one or more of the engine modules, based on the desired engine-module performance levels 28 determined for one or more of the engine modules. In one embodiment, determining the desired level of repair comprises determining the extent of repair needed to achieve the desired level of engine performance 28 associated with the engine modules. The engine module repair estimation component 30 may further be configured to determine optimal values for the levels of repair needed for the engine modules, based on a plurality of optimization criteria. The optimization criteria may include, for example, the overall amount of life-cycle cost associated with the engine repair/overhaul and/or the cost of performing the engine workscope. The engine module repair estimation component 30 is further configured to plan the repair/workscope 32 for the engine based on the desired engine-module performance levels 28 determined for one or more of the engine modules comprising the engine.

The module-health estimates determined in accordance with embodiments of the present invention can be used to provide insights on expected improvements to be made to the current module-specific health estimates so that overall engine efficiency and performance may be improved. For example, if the compressor efficiency degradation before the engine comes for repair is estimated to be 5%, then the engine repair/workscope can be expected to restore the compressor efficiency by about 5%. Further, the utilization of module-specific health estimates in accordance with embodiments of the present invention enables the repair and overhaul of the engine to be performed efficiently. For example, if the module-specific health estimate determined for the high pressure turbine (HPT) module comprising the engine is found to be normal prior to performing the workscope/repair for the engine, then the workscope/repair for the engine need not take into consideration the health of this module, except to account for any LLP's needed for the module. In other words, the determination of the module-specific health estimates enables the classification of the health of the engine, which can be used as a basis to plan and perform the repair/workscope for the engine, so that the repair and overhaul of the engine may be performed in less time, with increased accuracy and efficiency and reduced cost. Further, by automatically identifying engine-module specific repairs or overhauls from a workscope, desired performance levels in the workscope can be efficiently achieved.

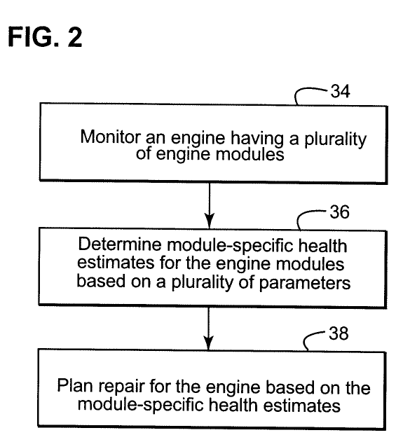

FIG. 2 illustrates one or more process steps that may be used by the system of FIG. 1, for planning repair of an engine. In step 34, an engine having a plurality of engine modules is monitored. In one embodiment, a plurality of sensors are configured to monitor a plurality of engine parameters related to the operation and performance of the engine. In one embodiment, the plurality of parameters include on-wing flight condition data and on-wing sensor data related to the engine. As mentioned above, the on-wing flight condition data may include, but is not limited to, altitude, aircraft mach number, bleed, ambient temperature, air speed, ambient pressure, fan speed and engine pressure ratio related to the engine and the on-wing sensor data may include, but is not limited to, exhaust gas temperature, rotor speeds, engine temperature, engine pressure, gas temperature, engine fuel flow, core speed, compressor discharge pressure, turbine exhaust pressure and fan speed related to the engine.

In step 36, one or more module-specific health estimates for one or more of the engine modules are determined, based on the plurality of engine parameters. Further, in one embodiment, the module-specific health estimates may include, but are not limited to a fan flow, a fan efficiency, a booster flow, a booster efficiency, a high pressure compressor flow, a high pressure compressor efficiency, a combustor efficiency, a high pressure turbine flow function, a high pressure turbine efficiency, a low pressure turbine flow function and a low pressure turbine efficiency related to the engine 18.

In a particular embodiment, determining one or more of the module-specific health estimates comprises evaluating one or more of the module-specific health estimates based on the plurality of engine parameters and a model of the engine. In one embodiment, the model 26 of the engine may include, but is not limited to, a physics-based model, a data fitting model (such as a regression model or a neural network model), a rule-based model, and an empirical model. In a particular embodiment, evaluating one or more of the module-specific health estimates further comprises determining a desired engine-module performance level for one or more of the engine modules comprising the engine.

In step 38, repair of the engine is planned based on one or more of the module-specific health estimates determined for one or more of the engine modules. In one embodiment, and as mentioned above, a desired level of repair for one or more of the engine modules is determined, based on the desired engine-module performance levels determined for one or more of the engine modules and the repair of the engine is planned based on the desired engine-module performance levels determined for one or more of the engine modules comprising the engine.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for planning repair of an engine, comprising:
monitoring an engine having a plurality of engine modules;
determining one or more module-specific health estimates for one or more of the engine modules, based on a plurality of engine parameters; and
planning repair of the engine based on one or more of the module-specific health estimates determined for one or more of the engine modules.

2. The method of claim 1, wherein the engine comprises at least one of an aircraft engine, a land based power generation engine and a marine transportation engine.

3. The method of claim 1, wherein the plurality of engine parameters comprises at least one of on-wing flight condition data and on-wing sensor data related to the engine.

4. The method of claim 3, wherein the on-wing flight condition data comprises at least one of altitude, aircraft mach number, bleed, ambient temperature, air speed, ambient pressure, fan speed and engine pressure ratio related to the engine.

5. The method of claim 3, wherein the on-wing sensor data comprises at least one of exhaust gas temperature, rotor speeds, engine temperature, engine pressure, gas temperature, engine fuel flow, core speed, compressor discharge pressure, turbine exhaust pressure and fan speed related to the engine.

6. The method of claim 1, wherein one or more of the module-specific health estimates comprises at least one of a fan flow, a fan efficiency, a booster flow, a booster efficiency, a high pressure compressor flow, a high pressure compressor efficiency, a combustor efficiency, a high pressure turbine flow function, a high pressure turbine efficiency, a low pressure turbine flow function and a low pressure turbine efficiency related to the engine.

7. The method of claim 1, wherein determining one or more of the module-specific health estimates further comprises evaluating one or more of the module-specific health estimates based on the plurality of engine parameters and a model of the engine.

8. The method of claim 7, wherein determining one or more of the module-specific health estimates further comprises using a parameter identification technique, wherein the parameter identification technique comprises at least one of a Kalman filter, a tracking filter, a regression map, a neural map, an inverse modeling technique or a combination thereof.

9. The method of claim 7, wherein the model of the engine comprises at least one of a physics-based model, a data fitting model, a rule-based model, and an empirical model.

10. The method of claim 7, wherein evaluating one or more of the module-specific health estimates further comprises determining a desired engine-module performance level for one or more of the engine modules comprising the engine.

11. The method of claim 10, further comprising determining a desired level of repair for one or more of the engine modules, based on the desired engine-module performance level determined for one or more of the engine modules.

12. The method of claim 11, further comprising planning repair of the engine based on the desired engine-module performance levels determined for one or more of the engine modules comprising the engine.

13. A system for planning repair of an engine, comprising:
an engine module health estimation component configured to determine one or more module-specific health estimates for one or more engine modules, based on a plurality of engine parameters;
an engine modeling component configured to evaluate one or more of the module-specific health estimates based on the plurality of engine parameters and a model of the engine; and
an engine module repair estimation component configured to plan repair of the engine based on one or more of the evaluated module-specific health estimates.

14. The system of claim 13, wherein the engine comprises at least one of an aircraft engine, a land based power generation engine and a marine transportation engine.

15. The system of claim 13, wherein the plurality of engine parameters comprises at least one of on-wing flight condition data and on-wing sensor data related to the engine.

16. The system of claim 15, wherein the on-wing flight condition data comprises at least one of altitude, aircraft mach number, bleed, ambient temperature, air speed, ambient pressure, fan speed and engine pressure ratio related to the engine.

17. The system of claim 15, wherein the on-wing sensor data comprises at least one of exhaust gas temperature, rotor speeds, engine temperature, engine pressure, gas temperature, engine fuel flow, core speed, compressor discharge pressure, turbine exhaust pressure and fan speed related to the engine.

18. The system of claim 13, wherein one or more of the module-specific health estimates comprises at least one of a fan flow, a fan efficiency, a booster flow, a booster efficiency, a high pressure compressor flow, a high pressure compressor efficiency, a combustor efficiency, a high pressure turbine flow function, a high pressure turbine efficiency, a low pressure turbine flow function and a low pressure turbine efficiency related to the engine.

19. The system of claim 13, wherein the engine module health estimation component is configured to determine one or more of the module-specific health estimates using a parameter identification technique, wherein the parameter identification technique comprises least one of a Kalman filter, a tracking filter, a regression map, a neural map, an inverse modeling technique or a combination thereof.

20. The system of claim 13, wherein the model of the engine comprises at least one of a physics-based model, a data fitting model, a rule-based model, and an empirical model.

21. The system of claim 13, wherein the engine modeling component is further configured to determine a desired engine-module performance level for one or more of the engine modules comprising the engine.

22. The system of claim 21, wherein the engine module repair estimation component is configured to determine a desired level of repair for one or more of the engine modules, based on the desired engine-module performance levels determined for one or more of the engine modules.

23. The system of claim 22, wherein the engine module repair estimation component is further configured to plan repair of the engine based on the desired engine-module performance levels determined for one or more of the engine modules comprising the engine.
